(19) United States
(12) Patent Application Publication
(10) Pub. No.: US 2014/0125657 A1
(43) Pub. Date: May 8, 2014

(54) Three Dimensional Modeling And Drawing Extraction Tool

(71) Applicant: Fluor Technologies Corporation, Aliso Viejo, CA (US)

(72) Inventor: Damodhar Murali, Gurgaon (IN)

(73) Assignee: Fluor Technologies Corporation, Aliso Viejo, CA (US)

(21) Appl. No.: 14/068,193

(22) Filed: Oct. 31, 2013

(30) Foreign Application Priority Data
Nov. 1, 2012 (IN) 3366/DELNP/2012

(51) Int. Cl. G06T 17/00

(52) U.S. Cl. CPC G06T 17/00
USPC 345/419

(57) ABSTRACT

A pile and foundation modeling system for creating a three-dimensional (3D) model of foundations is presented. In one aspect of the invention, the pile and foundation modeling system includes a foundation database that stores several configurable foundation geometries, an interface, and a modeling engine that is coupled to the interface and the foundation database. The interface is configured to receive foundation data that includes parameters associated with a construction project. The modeling engine is configured to (i) obtain the foundation data via the interface, (ii) instantiate pile and foundation objects based on applying the foundation data to the configurable foundation geometries, (iii) generate a three-dimensional pile and foundation model according to the instantiated pile and foundation objects, and (iv) configure an output device to render the three-dimensional pile and foundation model.

This application claims the benefit of priority to Indian patent application serial number 3366/DELNP/2012, filed Nov. 1, 2012, which is hereby incorporated by reference in its entirety.

### FIELD OF THE INVENTION

The field of the invention is three-dimensional foundation and superstructure modeling.

### BACKGROUND

The background description includes information that may be useful in understanding the present invention. It is not an admission that any of the information provided herein is prior art or relevant to the presently claimed invention, or that any publication specifically or implicitly referenced is prior art.

When planning a construction site, engineers and designers often use computer modeling systems, such as the computer-aided design (CAD) systems, to stimulate how the foundation, structures, and superstructures of the construction site may look like before they are actually built. Some of these computer modeling systems provide two-dimensional (2D) and/or three-dimensional (3D) modeling capabilities. In either case, the engineers and designers must provide enough information about the foundation and structures, such as the size of each perimeter, material used, shape, location, and also information of all the sub-components (e.g., piles, pilecaps, pedestals, etc.) of the foundation and structures, for the computer modeling system to create a realistic and accurate simulation of the construction site. In essence, every detail of the foundation, structures, and superstructures must be manually provided in order for the computer modeling system to render a 2D or 3D model, and any error on the input of the information will render the model inaccurate.

As a result, the process of simulating or modeling a construction site can be very labor-intensive and prone to error. Various systems and models have been suggested for making the process of 2D or 3D modeling more efficient. For example, U.S. Pat. No. 8,040,344 to Okada (issued in October, 2011) proposes a computer modeling system that aggregates data of common pipe spools in a plant to reduce the amount of diagrams and management workload. Another example is found in U.S. Pat. No. 7,913,190 to Grimaud et al. (issued in March, 2011), which teaches a computer modeling program interface that divides the screen into an area for viewing a real-time 3D model and another area for adding and modifying input data such that the 3D model is updated as a user modifies the input data.

Other examples of using a computer modeling system to simulate and model a construction site include:
A presentation by Husseini titled “Intergraph Process, Power, & Marine” (See URL www.intergraph.com/global/no/p2c2/documents/SP3D2009ProductUpdateNov-12-Sam.pdf), published Nov. 12, 2008; and
A presentation by Popov et al. titled “Plant Design Using SolidWorks Together with Solution Partner Products and Other Standard Industry Tools (See URL www.solidace.com/downloads/SWW2010-presentation21026-VPopov.pdf), published 2010.

However, none of the systems effectively simplify the process of creating a 2D or 3D construction site model. Thus, there is still a need for improving a construction site modeling system.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

### SUMMARY OF THE INVENTION

The inventive subject matter provides systems, apparatus, and methods for allowing a user to create a three-dimensional (3D) model of foundations by providing parameters for a set of foundations. One aspect of the inventive subject matter includes a pile and foundation modeling system that includes a foundation database that stores several configurable foundation geometries, an interface, and a modeling engine that is coupled to the interface and the foundation database. In some embodiments, the interface is configured to receive foundation data that includes parameters associated with a construction project. The modeling engine of some embodiments is configured to (i) obtain the foundation data via the interface, (ii) instantiate pile and foundation objects based on applying the foundation data to the configurable foundation geometries, (iii) generate a three-dimensional pile and foundation model according to the instantiated pile and foundation objects, and (iv) configure an output device to render the three-dimensional pile and foundation model.

In some embodiments, the foundation data that is received at the interface includes orientation data for configuring at least one pile and foundation object. In some of these embodiments, the foundation data includes at least one of location data, dimension data, pile cap data, and pedestal data. In some embodiments, the interface is further configured to receive the foundation data in a spreadsheet format.

In some embodiments, the three-dimensional pile and foundation model is generated within a virtual three-dimensional space defined by three axes. In these embodiments, the location data for configuring each pile and foundation object includes a coordinate for each of the three axes in the three-dimensional space.

In some embodiments, the configurable foundation geometries include at least one of the following: a rectangular geometry, a triangular geometry, a hexagonal geometry, and an octagonal geometry.

In generating the three dimensional pile and foundation model, the model engine of some embodiments is configured to convert the foundation data into a format that is readable by a standard three-dimensional model program. In some embodiments, the standard three-dimensional model program is a plant design system (PDS) program. In addition to generating the three-dimensional pile and foundation model, the modeling engine of some embodiments is further configured to generate a two-dimensional pile and foundation model according to the pile and foundation objects.

In yet some other embodiments, the modeling engine is also configured to generate a sketch of the pile and foundation model. In some of these embodiments, the sketch is generated in at least one of the following formats: a computer-aided design (CAD) format, a MicroStation design file (DGN) format, and a SmartSketch file format.

In some embodiments, the pile and foundation modeling system also includes an error detection engine that is configured to detect errors in the foundation data. In some of these embodiments, the error detection engine is also configured to report the detected errors via an output device coupled to the error detection engine.

In some embodiments, each foundation includes one or more piles. As such, the pile and foundation modeling system of some embodiments also includes a pile database that stores several configurable pile types. Each pile type includes information related to a pile section, a material, a grade, a shape, and a size. In some of these embodiments, the modeling engine is configured to instantiate the pile and foundation objects based on applying the foundation data to the configurable pile types.

In another aspect of the inventive subject matter, a two-dimensional model extraction method is contemplated. The two-dimensional model extraction method receives data in a SDNF file format or a CIMSteel file format. The method extracts a two-dimensional model by generating several two-dimensional steel structures based on the received data without first rendering a three-dimensional model based on the data. The method configures a display device to present a visual presentation of the two-dimensional model.

In some embodiments, the two-dimensional model is one of a foundation model and a super-structure model. In some embodiments, the received data includes at least one of a location data, material data, dimensional data, and orientation data.

In some embodiments, the visual presentation of the two-dimensional model is provided in a virtual two-dimensional space defined by two axes. In these embodiments, the location data of a steel structure includes a coordinate for each of the two axes in the two-dimensional space.

In some embodiments, the method also includes generating a sketch of the two-dimensional model. The sketch includes at least one of the following formats: a computer-aided design (CAD) format, a MicroStation design file (DGN) format, and a SmartSketch file format.

### BRIEF DESCRIPTION OF THE DRAWING

FIG. 1 illustrates an example hazard management system.

FIG. 2 illustrates examples of hazard objects of a construction site.

FIG. 3 illustrates other examples of hazard objects of a construction site.

FIG. 4 illustrates an example graphical representation of different pile and foundation objects created by a hazard management system of some embodiments.

FIG. 5 illustrates a process of modeling pile and foundation according to some embodiments of the invention.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

It should be noted that while the following description is drawn to a computer/server based hazard management system, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document, the terms “coupled to” and “coupled with” are also used euphemistically to mean “communicatively coupled with” over a network where two or more devices are configured to exchange data over the network, possibly via one or more intermediary devices.

According to some aspects of the present invention, a pile and foundation modeling system is presented. Specifically, the pile and foundation modeling system of some embodiments provide an efficient way to create a three-dimensional (3D) model of a construction site that includes one or more foundations. In these embodiments, the pile and foundation modeling system stores information of several standard foundation geometries, and allows a user to only provide configuration information for instantiating one or more foundation objects by using the configuration information to configure the standard foundation geometries. This way, the user needs not repeatedly input the basic parameters (e.g., such as size of each perimeter, shape, number of piles and pilecaps, etc.) each time a new pile and foundation model is created.

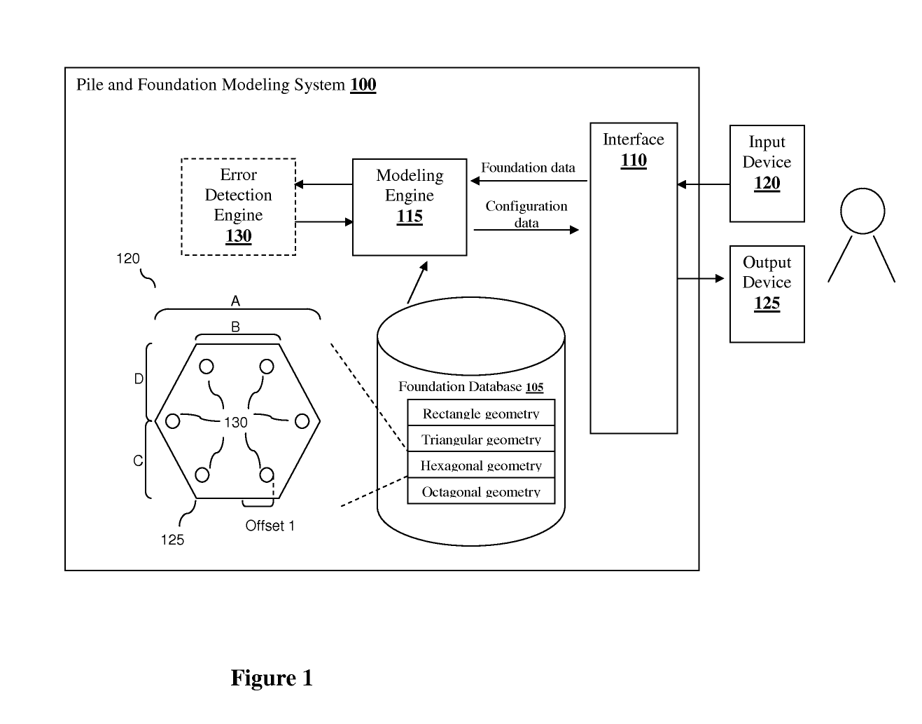

FIG. 1 illustrates a pile and foundation modeling system 100 of some embodiments. As shown, the pile and foundation modeling system 100 includes a foundation database 105, an interface 110, and a modeling engine 115. In some embodiments, the foundation database 105 stores information of several standard foundation geometries, such as a rectangular geometry, a triangular geometry, a hexagonal geometry, and an octagonal geometry. FIG. 1 also illustrates an example hexagonal geometry 120. As shown, hexagonal geometry 120 includes a hexagonal shaped pile base (also known as pile cap) and six piles 130. In particular, the hexagonal geometry 120 shown in this figure has an orientation in a way that the shape includes two horizontal perimeters. In addition, the piles 130 are positioned near each corner of the hexagonal geometry 120.

The standard foundation geometries that are stored in the foundation database 105 represent the basic geometrical structures of foundation pile caps. The pile and foundation modeling system of some embodiments allows a user to customize these basic structures to a foundation pile cap with desired size, shape, and sub-component features. For example, the modeling engine 115 of some embodiments associates different parameters with the hexagonal geometry 120 to further customize a foundation pile cap. In this example, the hexagonal geometry 120 includes 5 different parameters: “A”, “B”, “C”, “D”, and “Offset 1”. Parameter “A” represents the horizontal size of the hexagonal geometry 120. Parameter “B” represents the size of the horizontal perimeters. Parameter “C” represents the size of the lower vertical portion of the hexagonal geometry 120 and Parameter “D” represents the size of the upper vertical portion of the hexagonal geometry 120. Lastly, Parameter “Offset 1” represents the distance between the vertical axis of the hexagonal geometry 120 and the next pile to the right. As such, with different parameter values, the hexagonal geometry 120 can be customized in many different ways. For example, by manipulating Parameters A and B, one can adjust the horizontal size of the hexagonal geometry 120. In a similar manner, one can adjust the vertical size of the hexagonal geometry 120 by manipulating Parameters “C” and “D”. In addition, one can also manipulate the “Offset 1” parameter to adjust the position of the piles with respect of the geometry.

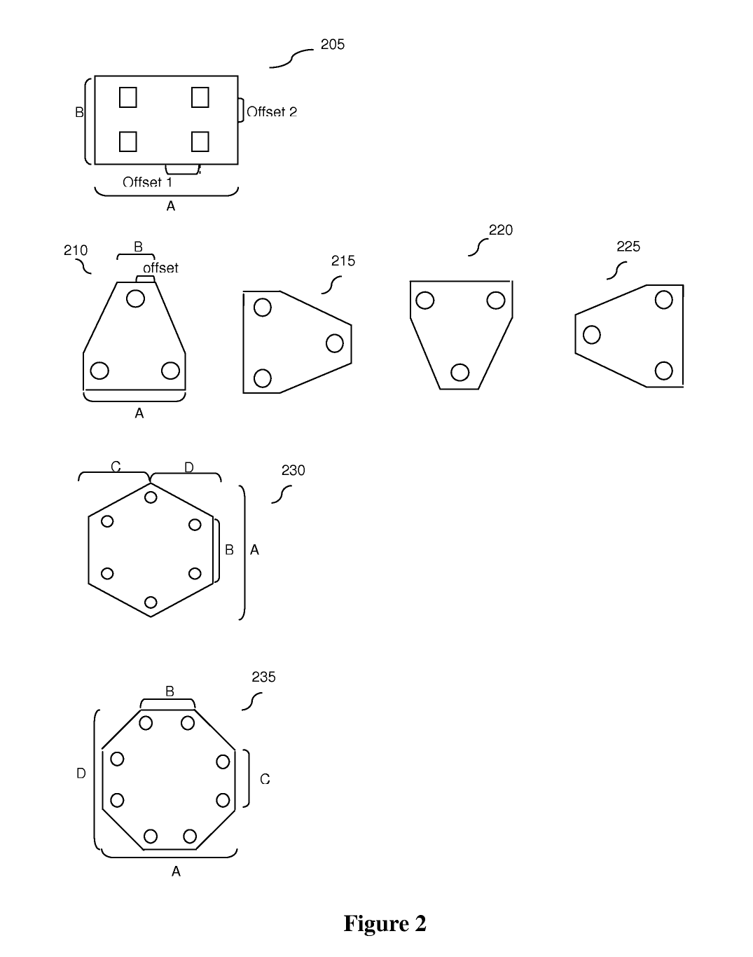

FIG. 2 illustrates several other examples of standard foundation geometries (stored in the foundation database 105) that can be customized using different parameters. For example, geometry 205 is a rectangular geometry. As shown, the modeling engine 115 of some embodiments associates Parameter “A” to the horizontal size of the rectangular geometry 205. The modeling engine 115 also associates Parameter “B” with the vertical size of the rectangular geometry 205. In addition, the modeling engine 115 provides Parameters “Offset 1” and “Offset 2” for adjusting the location of the piles with respect to the rectangular geometry 205.

Geometries 210-225 are triangular geometries with different orientations. Specifically, triangular geometry 210 is in the north orientation, triangular geometry 215 is in the east orientation, triangular geometry 220 is in the south orientation, and triangular geometry 225 is in the west orientation. In this example, Parameters “A”, “B”, “C”, and “D” represent the horizontal and vertical sizes of the triangular geometry 220 while Parameter “Offset 1” is used to adjust the location of the piles with respect of the triangular geometry 220.

Geometry 230 is another example of a hexagonal geometry that is in a different orientation than the hexagonal geometry 120. In this example, Parameters “A”, “B”, “C”, “D” are associated with the hexagonal geometry 230 to adjust the dimensions of the geometry. FIG. 2 also illustrates geometry 235, which is an octagonal geometry. Similar to the other geometries, different parameters (e.g., Parameters “A”, “B”, “C”, “D”) can be associated with the geometry to adjust the dimensions of the octagonal geometry 235.

It is noted that FIG. 2 only intends to illustrates a non-exclusive list of geometries that can be stored in the foundation database 105. One skilled in the art would appreciate that other foundation geometries, that are in other shapes or user-defined shapes, can be defined within the pile and foundation modeling system 100. Once a new geometry is defined in the foundation database 105, a user may specify a foundation using that geometry in the foundation data.

Referring back to FIG. 1, the interface 110 of some embodiments is configured to receive foundation data from a user. The foundation data includes parameters that are associated with a construction project. In addition, the foundation data also includes values that define the properties (e.g., shape, size, dimensions, orientation, etc.) of a foundation using the standard geometries that are stored in the foundation database 105.

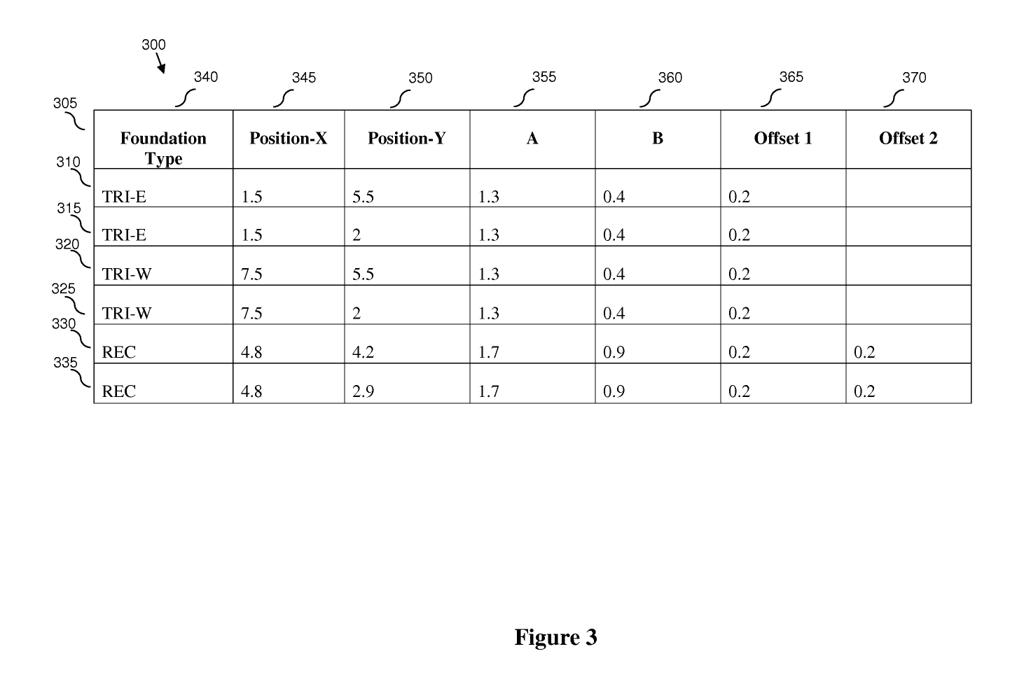

In some embodiments, the interface 110 of the pile and foundation modeling system 100 receives foundation data in a spreadsheet format. FIG. 3 illustrates an example set of foundation data that is provided by a user to the pile and foundation modeling system 100 via the interface 110. As shown in FIG. 3, the set of foundation data 300 includes seven rows (rows 305-335) and seven columns (columns 340-370). The first row 305 of the foundation data 300 illustrates the type of data under each column. For example, information under column 340 specifies the foundation type of each foundation. As described above by reference to FIG. 2, a foundation type can specify a geometry (e.g., a rectangular geometry, a triangular geometry, a hexagonal geometry, a octagonal geometry, etc.) and an orientation (e.g., south, north, east, west, north-south, east-west, etc.).

In some embodiments, the location of each foundation within the pile and foundation system 100 is expressed according to a Cartesian coordinate system along a horizontal axis (x-axis) and a vertical axis (y-axis). Under this system, the location of each foundation can be expressed by a pair of coordinates (x, y). Within the foundation data 300, information under columns 345 and 350 specifies the horizontal (“Position-X” parameter) and vertical (“Position-Y” parameter) coordinates for the foundations.

As described above by reference to FIG. 2, each geometry is configurable using the different parameters. The different parameters specify the lengths of several sides of the geometry and the positions of the pile caps within the foundation. Accordingly, information under column 355 specifies the “A” parameters for the foundations, information under column 360 specifies the “B” parameters for the foundations, information under column 365 specifies the “Offset 1” parameters for the foundations, and information under column 370 specifies the “Offset 2” parameters for the foundations.

Each of rows 310 to 335 includes information that specifies the parameters for a foundation. For example, row 310 includes information that specifies a triangular foundation with an east orientation, located at the (1.5, 5.5) position on the Cartesian plane, with an “A” parameter value of 1.3, a “B” parameter value of 0.4, and an “Offset 1” value of 0.2. Similar to row 310, rows 315 to 325 include information that specifies three different triangular foundations with different orientations and locations. Row 330 includes information that specifies a rectangular foundation, with a location at the (4.8, 2.9) position on the Cartesian plane, with an “A” parameter value of 1.7, a “B” parameter value of 0.9, an “Offset 1” value of 0.2, and an “Offset 2” value of 0.2. Row 335 includes information that specifies a rectangular foundation that is similar to the one of row 330, but at a different location (4.8, 4.2) on the Cartesian plane.

Referring back to FIG. 1, upon receiving the foundation information, the interface 110 passes the foundation data to the modeling engine 115. Based on the foundation data, the modeling engine 115 instantiates a set of pile and foundation objects. As mentioned above, the foundation database 105 of some embodiments store several standard foundation geometries that are configurable. In some of these embodiments, the modeling engine 115 instantiates the set of pile and foundation objects by applying the received foundation data to configure one or more of the standard foundation geometries.

As an example, upon receiving the foundation data 300, the modeling engine 115 instantiates a pile and foundation object for each row of information within foundation data 300. Since the information provided in row 310 specifies a triangular foundation, the modeling engine 115 instantiates a pile and foundation object using a standard triangular geometry for row 310 and then applying the different parameter values to further configure the pile and foundation object. The modeling engine 115 then uses the same process to instantiate five additional pile and foundation objects for rows 315 to 335.

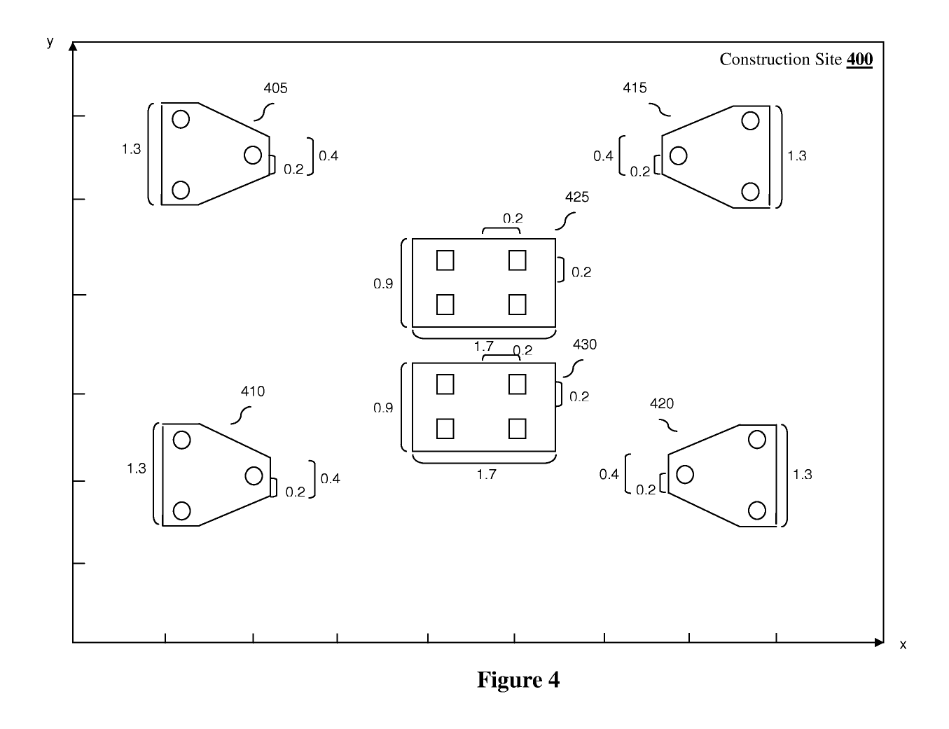

FIG. 4 illustrates a graphical representation of the different pile and foundation objects created by the modeling engine 115 based on foundation data 300. As shown, FIG. 4 includes a construction site grid 400 that represents an actual construction site. Although the construction site grid 400 in this example appears to be rectangular, one who is skilled in the art would appreciate that the construction grid 400 can be of different regular or irregular shapes and different sizes, depending on the shape and size of the actual construction site. In addition, the construction site grid 400 is modeled after a Cartesian plane with a horizontal axis (x-axis) and a vertical axis (y-axis). One skilled in the art would also appreciate that the construction site grid of some other embodiments can be modeled after any other coordinate system (e.g., Polar coordinate system, etc.).

FIG. 4 also illustrates six different pile and foundation objects 405 to 430 within the construction site grid 400. In this example, these pile and foundation objects 405 to 430 are created by the modeling engine 115 of the pile and foundation modeling system 100 based on the foundation data 300. For example, pile and foundation object 405 is created by the modeling engine 115 based on the information provided in row 310 of foundation data 300. As shown, since the information provided in row 310 specifies a triangular foundation, the pile and foundation object 405 is created based on a standard triangular geometry from the foundation database 105. The modeling engine 115 also further configures the pile and foundation object 405 by applying the information provided in row 310 to the standard triangular geometry. For example, based on the information provided in row 310, the modeling engine 115 configures the pile and foundation object to have an east orientation, with the longer base having a length of 1.3 units of measurement and a shorter base having a length of 0.4 units of measurement.

The modeling engine 115 also configures the pile and foundation object 405 to include a pile offset of 0.2 units of measurement. In addition, the modeling engine 115 configures the pile and foundation object 405 to be located at the coordinate (1.5, 5.5) on the construction grid 400, as shown in the figure.

Pile and foundation object 410 is created by the modeling engine 115 based on information provided in row 315 of foundation data 300. As shown, since the information provided in row 315 specifies a triangular foundation, the pile and foundation object 410 is created based on a standard triangular geometry from the foundation database 105. The modeling engine 115 also further configures the pile and foundation object 410 by applying the information provided in row 315 to the standard triangular geometry. For example, based on the information provided in row 315, the modeling engine 115 configures the pile and foundation object to have an east orientation, with the longer base having a length of 1.3 units of measurement and a shorter base having a length of 0.4 units of measurement. The modeling engine 115 also configures the pile and foundation object 410 to include a pile offset of 0.2 units of measurement. In addition, the modeling engine 115 configures the pile and foundation object 410 to be located at the coordinate (1.5, 2), below the pile and foundation object 405, on the construction grid 400, as shown in the figure.

Modeling engine 115 also created pile and foundation object 415 based on information provided in row 320 of foundation data 300. As shown, since the information provided in row 320 specifies a triangular foundation, the pile and foundation object 415 is created based on a standard triangular geometry from the foundation database 105. The modeling engine 115 also further configures the pile and foundation object 415 by applying the information provided in row 320 to the standard triangular geometry. For example, based on the information provided in row 320, the modeling engine 115 configures the pile and foundation object to have a west orientation, with the longer base having a length of 1.3 units of measurement and a shorter base having a length of 0.4 units of measurement. The modeling engine 115 also configures the pile and foundation object 415 to include a pile offset of 0.2 units of measurement. In addition, the modeling engine 115 configures the pile and foundation object 415 to be located at the coordinate (7.5, 5.5) on the construction grid 400, as shown in the figure.

Modeling engine 115 also created pile and foundation object 420 based on information provided in row 325 of foundation data 300. As shown, since the information provided in row 325 specifies a triangular foundation, the pile and foundation object 420 is created based on a standard triangular geometry from the foundation database 105. The modeling engine 115 also further configures the pile and foundation object 420 by applying the information provided in row 325 to the standard triangular geometry. For example, based on the information provided in row 325, the modeling engine 115 configures the pile and foundation object to have a west orientation, with the longer base having a length of 1.3 units of measurement and a shorter base having a length of 0.4 units of measurement. The modeling engine 115 also configures the pile and foundation object 420 to include a pile offset of 0.2 units of measurement. In addition, the modeling engine 115 configures the pile and foundation object 420 to be located at the coordinate (7.5, 2), below the pile and foundation object 415, on the construction grid 400, as shown in the figure.

Pile and foundation object 425 is created by the modeling engine 115 based on information provided in row 330 of foundation data 300. As shown, since the information provided in row 330 specifies a rectangular foundation, the pile and foundation object 425 is created based on a standard rectangular geometry from the foundation database 105. The modeling engine 115 also further configures the pile and foundation object 425 by applying the information provided in row 330 to the standard rectangular geometry. For example, based on the information provided in row 330, the modeling engine 115 configures the pile and foundation object to have the longer side having a length of 1.7 units of measurement and a shorter side having a length of 0.9 units of measurement. The modeling engine 115 also configures the pile and foundation object 425 to include a pile offset of 0.2 units of measurement for each of the two dimensions of the foundation. In addition, the modeling engine 115 configures the pile and foundation object 425 to be located at the coordinate (4.8, 4.2) on the construction grid 400, as shown in the figure.

Pile and foundation object 430 is created by the modeling engine 115 based on information provided in row 335 of foundation data 300. As shown, since the information provided in row 335 specifies a rectangular foundation, the pile and foundation object 430 is created based on a standard rectangular geometry from the foundation database 105. The modeling engine 115 also further configures the pile and foundation object 430 by applying the information provided in row 335 to the standard rectangular geometry. For example, based on the information provided in row 335, the modeling engine 115 configures the pile and foundation object to have the longer side having a length of 1.7 units of measurement and a shorter side having a length of 0.9 units of measurement. The modeling engine 115 also configures the pile and foundation object 430 to include a pile offset of 0.2 units of measurement for each of the two dimensions of the foundation. In addition, the modeling engine 115 configures the pile and foundation object 430 to be located at the coordinate (4.8, 2.9), below the pile and foundation object 425, on the construction grid 400, as shown in the figure.

The above example illustrated that the model engine 115 instantiates a set of pile and foundation objects 405-430 based on information from the foundation data 300. In some embodiments, an instantiated pile and foundation object is an individual, self-contained entity within the pile and foundation modeling system 100. As such, each instantiated pile and foundation object has a set of attributes (e.g., location information, shape, orientation, sizes of the dimensions, other parameter values, etc.) that represent the characteristics of a foundation. In some embodiments, a pile and foundation object may inherit attributes from other objects. For example, the pile and foundation modeling system 100 of some embodiments creates a foundation geometry object for each of the foundation geometries that are stored in the foundation database 105. Each of the foundation geometry objects includes attributes (e.g., shape, orientation, etc.) that represent a standard foundation geometry. In these embodiments, each pile and foundation object may inherit from one of the foundation geometry objects.

In addition, each pile and foundation object of some embodiments may also include other objects. For example, a pile and foundation object may include one or more pile objects. Each pile object includes attributes (e.g., pile section, size, shape, material, grade, etc.) that represent a pile within a foundation. By separating the pile objects from the pile and foundation objects, a user can modify the characteristics of a pile (e.g., by modifying the attributes of the pile object) independent of the pile and foundation objects. Furthermore, a user may specify the characteristics of the pile within each foundation by supplying parameter values to the pile objects within the foundation data 300.

Once the set of pile and foundation objects are instantiated, the modeling engine 115 can further configure the pile and foundation objects based on new input provided by the user through the interface 105. For example, the user may provide input to change the length of the different dimension of the foundation, the location, the orientation, etc. In addition, the user may add new pile and foundation objects to or remove existing pile and foundation objects from the construction site grid 400 through the interface 105.

Since the pile and foundation modeling system 100 of some embodiments allows the user to input foundation data in a batch (e.g., in a spreadsheet format), the user may inadvertently provide unrealistic parameter values for the foundations (e.g., non-positive numerical values, sizes being too small for the geometry, foundations being too close (or overlapped) with each other, etc.). Therefore, referring back to FIG. 1, the pile and foundation modeling system 100 of some embodiments also include an error detection engine 130. The error detection engine 130 is configured to detect errors within the foundation data received through the interface 110. The error detection engine 130 of some embodiments is a stand-alone module that is separate from the modeling engine 115. In other embodiments, the error detection engine 130 is integrated into the modeling engine 115. Once the error detection engine 130 detects an error within the foundation data, the error detection engine 130 of some embodiments is configured to report the detected errors via an output device (e.g., the output device 125).

After all pile and foundation objects have been instantiated based on the foundation data 300, the modeling engine 115 of some embodiments generates a multi-dimensional (e.g., two-dimensional, three-dimensional, etc.) pile and foundation model according to the instantiated pile and foundation objects. In some of these embodiments, the multi-dimensional pile and foundation model is generated within a virtual multi-dimensional space defined by a set of axes, where the location information of each foundation within the foundation data includes coordinates for each of the set of axes.

In some embodiments, the modeling engine 115 generates the three-dimensional pile and foundation model by generating pile and foundation model data in a format that is readable by a commercially available plant design system (PDS) program. An example of such a plant design system (PDS) program is the SmartPlant® 3D program developed by Intergraph® Corporation. In some embodiments, the pile and foundation model data is generated in a format that is widely known in the industry such as the computer-aided design (CAD) format, the MicroStation design file (DGN) format, and the SmartSketch file format.

In another aspect of the invention, a method for extracting a two-dimensional model for a plant construction is presented. Specifically, the method receives construction plant data and extracts a two-dimensional model from the data without rendering a three-dimensional model based on the data. In some embodiments, the model is a superstructure model of a construction plant.

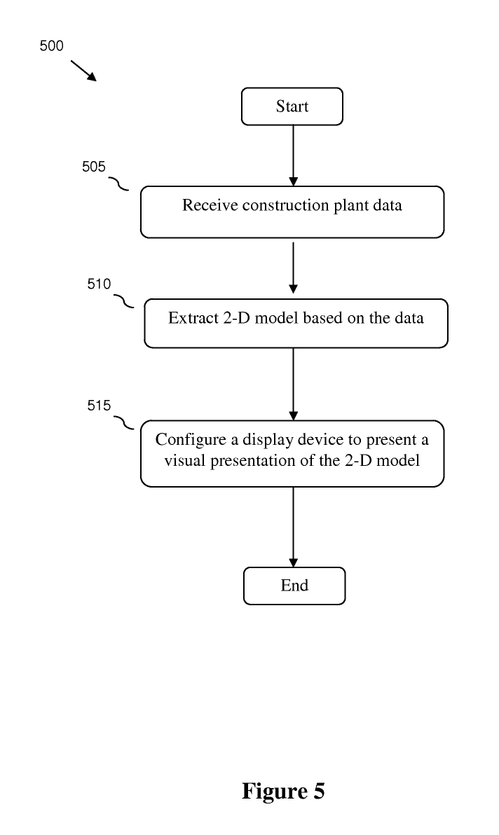

FIG. 5 conceptually illustrates this two-dimensional model extraction process 500 of some embodiments. As shown, the process receives (at 505) data in either a steel detailing neutral format (SDNF) file format or a CIMSteel file format. The SDNF file format and the CIMSteel are standard data format in the plant construction industry as input files for a plant construction three-dimensional modeling system to generate a three-dimensional plant construction model.

In some embodiments, the received data includes location data, material data, dimension data, and orientation data of a set of super-structure of a construction plant. The process then extracts (at 510) a two-dimensional model by generating several two-dimensional steel structures based on the received data. In some embodiments, the two-dimensional steel structures are generated in a virtual two-dimensional space that is defined by two axes (e.g., an x-axis and a y-axis). As such, the received data in these embodiments include information that can derive at least a set of coordinates (x, y) for each steel structure.

In some embodiments, the process extracts the two-dimensional model without first rendering a three-dimensional model based on the received data. After extracting the two-dimensional model, the process configures (at 515) a display device to present a visual presentation of the extracted two-dimensional model. In some embodiments, by extracting the two-dimensional model of the construction plant, the process also generates a sketch of the two-dimensional model in a format that is widely known in the construction plant industry. Some examples of the sketch format include a computer-aided design (CAD) format, a MicroStation design file (DGN) format, and a SmartSketch file format.

Although the example above illustrates a method for extracting a two-dimensional superstructure model based on either a SDNF or CIMSteel format, one skilled in the art would appreciate that the same method can be used to extract a two-dimensional foundation model from data in the same formats.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A pile and foundation modeling system comprising:
a foundation database storing a plurality of configurable foundation geometries;
an interface configured to receive foundation data, the foundation data comprising parameters associated with a construction project; and
a modeling engine coupled to the interface and the foundation database, and configured to:
obtain the foundation data via the interface;
instantiate pile and foundation objects based on applying the foundation data to the configurable foundation geometries;
generate a three-dimensional pile and foundation model according to the pile and foundation objects;
configure an output device to render the three-dimensional pile and foundation model.

2. The pile and foundation modeling system of claim 1, wherein the foundation data comprises orientation data for at least one pile and foundation object.

3. The pile and foundation modeling system of claim 1, wherein the foundation data comprises at least one of the following for at least one pile and foundation object: location data, dimension data, pile cap data, and pedestal data.

4. The pile and foundation modeling system of claim 3, wherein the three-dimensional pile and foundation model is generated within a virtual three-dimensional space defined by three axes, wherein the location data for configuring each pile and foundation object comprises a coordinate for each of the three axes of the three-dimensional space.

5. The pile and foundation modeling system of claim 1, wherein the plurality of configurable foundation geometries comprises at least one of the following: a rectangular geometry, a triangular geometry, a hexagonal geometry, and an octagonal geometry.

6. The pile and foundation modeling system of claim 1, wherein the modeling engine is further configured to generate a two-dimensional pile and foundation model according to the pile and foundation objects.

7. The pile and foundation modeling system of claim 1, wherein the interface is further configured to receive the foundation data in a spreadsheet format.

8. The pile and foundation modeling system of claim 1, wherein the modeling engine is further configured to generate the three-dimensional pile and foundation model by converting the foundation data into a format that is readable by a three-dimensional model program.

9. The pile and foundation modeling system of claim 8, wherein the three-dimensional model program is a plant design system (PDS) program.

10. The pile and foundation modeling system of claim 1, further comprising an error detection engine that is configured to detect errors in the foundation data.

11. The pile and foundation modeling system of claim 10, wherein the error detection engine is further configured to report the detected errors via an output device coupled to the error detection engine.

12. The pile and foundation modeling system of claim 1, further comprising a pile database storing a plurality of configurable pile types, each configurable pile type comprising information related to a pile section, a material, a grade, a shape and a size.

13. The pile and foundation modeling system of claim 12, wherein the modeling engine is further configured to instantiate the pile and foundation objects based on applying the foundation data to the configurable pile types.

14. The pile and foundation modeling system of claim 13, wherein each foundation comprises a plurality of piles.

15. The system of claim 1, wherein the modeling engine is further configured to generate a sketch of the model.

16. The system of claim 15, wherein the sketch includes at least one of the following formats: a computer-aided design (CAD) format, a MicroStation design file (DGN) format, and a SmartSketch file format.

17. A two-dimensional model extraction method, comprising
receiving data in a steel detailing neutral format (SDNF) file format or a CIMSteel file format;
extracting a two-dimensional model by generating a plurality of two-dimensional steel structures based on the received data without first rendering a three-dimensional model based on the data; and
configuring a display device to present a visual presentation of the two-dimensional model.

18. The two-dimensional model extraction method of claim 17, wherein the two dimensional model is one of the following: a foundation model and a super-structure model.

19. The two-dimensional model extraction method of claim 17, wherein the received data comprises at least one of the following: location data, material data, dimension data, and orientation data.

20. The two-dimensional model extraction method of claim 17, wherein the visual presentation of the two-dimensional model is provided in a virtual two-dimensional space defined by two axes.

21. The two-dimensional model extraction method of claim 20, wherein the location data of a steel structure comprises a coordinate for each of the two axes of the two-dimensional space.

22. The two-dimensional model extraction method of claim 17, furthering comprising generating a sketch of the two-dimensional model.

23. The system of claim 22, wherein the sketch includes at least one of the following formats: a computer-aided design (CAD) format, a MicroStation design file (DGN) format, and a SmartSketch file format.
